(19) United States
(12) Patent Application Publication
(10) Pub. No.: US 2013/0100585 A1
(43) Pub. Date: Apr. 25, 2013

(54) ELECTROCONDUCTIVE POLYMER SUSPENSION AND METHOD FOR PRODUCING THE SAME, ELECTROCONDUCTIVE POLYMER MATERIAL, AND SOLID ELECTROLYTIC CAPACITOR AND METHOD FOR PRODUCING THE SAME

(71) Applicant: NEC Tokin Corporation, Sendai-shi (JP)

(72) Inventors: Satoshi SUZUKI, Sendai-shi (JP); Tomoki Nobuta, Sendai-shi (JP); Yasuhisha Sugawara, Sendai-shi (JP); Yasuhiro Tomioka, Sendai-shi (JP)

(73) Assignee: NEC Tokin Corporation, Sendai-shi (JP)

(21) Appl. No.: 13/649,634

(22) Filed: Oct. 11, 2012

(30) Foreign Application Priority Data
Oct. 14, 2011 (JP) 2011-226381

(51) Int. Cl. H01G 9/025; H01G 9/00

(52) U.S. Cl. CPC H01G 9/025; H01G 9/0032
USPC 361/525; 252/62.2; 427/80; 427/487

(57) ABSTRACT

The present invention provides an electroconductive polymer suspension for providing an electroconductive polymer material with a high electroconductivity and a method for producing the same, and particularly provides a solid electrolytic capacitor with a low ESR and a method for producing the same. It includes a first step of carrying out chemical oxidative polymerization of a monomer providing an electroconductive polymer by using an oxidant in a solvent containing a first dopant including an organic acid or a salt thereof to synthesize an electroconductive polymer; a second step of purifying the electroconductive polymer; a third step of adding a second dopant, mixing an oxidant, subsequently adding a third dopant, and further mixing an oxidant in an aqueous solvent containing the purified electroconductive polymer; and a fourth step of carrying out an ion-exchange treatment to the mixture liquid obtained by the third step to obtain an electroconductive polymer suspension.

This application is based upon and claims the benefit of priority from Japanese patent application No. 2011-226381, filed on Oct. 14, 2011, the disclosure of which is incorporated herein in its entirety by reference.

### BACKGROUND OF THE INVENTION

1. Field of the Invention

The present invention relates to an electroconductive polymer suspension and a method for producing the same, an electroconductive polymer material, and a solid electrolytic capacitor and a method for producing the same.

2. Description of the Related Art

Electroconductive organic materials are used for an electrode of a condenser, an electrode of a dye-sensitized solar cell or an organic thin film solar cell, and an electrode of an electroluminescence display. As these electroconductive organic materials, electroconductive polymers obtained by polymerizing pyrrole, thiophene, aniline or the like are known.

These electroconductive polymers are generally provided as a suspension (dispersion) or a solution in an aqueous solvent, or as a solution in an organic solvent, and the solvent is removed at the time of use and is used as an electroconductive polymer material. However, even if the kind of the electroconductive polymer is the same, since the property of the electroconductive polymer material obtained is different depending on the condition of the dispersion, methods for producing a dispersion are variously studied.

JP 2010-40776 A discloses a technology regarding a suspension (dispersion) of a polythiophene and a method for producing the same. The dispersion of a polythiophene contains water or a mixture of a water-miscible organic solvent with water as a dispersing medium, a polythiophene consisting of a structural unit of 3,4-ethylenedioxythiophene, and a polyanion derived from a polystyrene sulfonic acid with a molecular weight in a range of 2000 to 500000. And, the polythiophene was obtained by chemical oxidative polymerization in a presence of the polyanion derived from a polystyrene sulfonic acid with a molecular weight in a range of 2000 to 500000. It is assumed that an electroconductive polymer film can be formed by the method.

JP 2006-228679 A discloses a technology regarding an electroconductive polymer composition and a solid electrolytic capacitor using the same. It contains naphthalenesulfonic acid as an additive which is added to a cationic polymer consisting of repetitive structural units of 3,4-ethylenedioxythiophene and an electroconductive polymer obtained by using a polystyrene sulfonic acid as an anion. It is assumed that an electroconductive polymer coating film with keeping low specific resistivity can be obtained by the technology.

However, like the technology described in JP 2010-40776 A, the method by chemical oxidative polymerization of 3,4-ethylenedioxythiophene in a presence of a polyanion makes it difficult to improve the dope rate. Also, like the technology described in JP 2006-228679 A, the method in which naphthalenesulfonic acid is added as an additive to an electroconductive polymer obtained by using a polystyrene sulfonic acid as an anion also makes it difficult to improve the dope rate. That is, there was a problem that a polyanion that is an undoped polyanion which does not contribute to the electroconductivity excessively exists and that it is not adequate as a technology to obtain an electroconductive polymer material with a higher electroconductivity.

Thus, the object of the present invention is to provide an electroconductive polymer suspension for providing an electroconductive polymer material with a high electroconductivity and a method for producing the same, and particularly provides a solid electrolytic capacitor with a low equivalent series resistance (low ESR) and a method for producing the same.

### SUMMARY OF THE INVENTION

The method for producing an electroconductive polymer suspension of the present invention includes:

a first step of carrying out a chemical oxidative polymerization of a monomer providing an electroconductive polymer by using an oxidant in a solvent containing a first dopant including an organic acid or a salt thereof to synthesize an electroconductive polymer;

a second step of purifying the electroconductive polymer;

a third step of adding a second dopant, mixing an oxidant, subsequently adding a third dopant, and further mixing an oxidant in an aqueous solvent containing the purified electroconductive polymer; and

a fourth step of carrying out an ion-exchange treatment to the mixture liquid obtained by the third step to obtain an electroconductive polymer suspension.

Also, the monomer is preferably at least one kind selected from pyrrole, thiophene, aniline, and derivatives thereof, and is particularly preferably 3,4-ethylenedioxythiophene.

Also, the first dopant and/or the second dopant are preferably at least one kind selected from a polysulfonic acid or a salt thereof, and are particularly preferably a polystyrene sulfonic acid.

Also, the third dopant is preferably at least one kind selected from an organic acid with a low molecular weight or a salt thereof, and is particularly preferably at least one kind selected from alkyl sulfonic acids, benzenesulfonic acid, naphthalenesulfonic acid, anthraquinonesulfonic acid, camphorsulfonic acid and derivatives thereof and iron (Ill) salts thereof.

Also, it may include a fifth step of mixing at least one kind selected from erythritol and pentaerythritol after the fourth step.

The electroconductive polymer suspension of the present invention is obtained by the above-mentioned method. Also, the electroconductive polymer material of the present invention is obtained by removing the solvent from the above-mentioned electroconductive polymer suspension.

The solid electrolytic capacitor of the present invention has a solid electrolyte layer containing the above-mentioned electroconductive polymer material and may have an anode conductor containing a valve action metal and a dielectric layer formed on a surface of the anode conductor, wherein the solid electrolyte layer is formed on the dielectric layer. Also, the solid electrolyte layer may include a first solid electrolyte layer formed on the dielectric layer and a second solid electrolyte layer formed on the first solid electrolyte layer, and the valve action metal may be at least one kind selected from aluminum, tantalum and niobium.

The method for producing a solid electrolytic capacitor of the present invention includes:

forming a dielectric layer on a surface of an anode conductor containing a valve action metal; and

carrying out application or impregnation of the electroconductive polymer suspension on the dielectric layer and removing the solvent from the electroconductive polymer suspension to form a solid electrolyte layer containing an electroconductive polymer material.

The method for producing a solid electrolytic capacitor of the present invention includes:

forming a dielectric layer on a surface of an anode conductor containing a valve action metal;

carrying out a chemical oxidative polymerization or electropolymerization of a monomer providing an electroconductive polymer on the dielectric layer to form a first solid electrolyte layer containing the electroconductive polymer; and

carrying out application or impregnation of the electroconductive polymer suspension on the first solid electrolyte layer and removing the solvent from the electroconductive polymer suspension to form a second solid electrolyte layer.

Also, the electroconductive polymer contained in the first solid electrolyte layer is preferably a polymer obtained by chemical oxidative polymerization or electropolymerization of at least one kind selected from pyrrole, thiophene, 3,4-ethylenedioxythiophene, aniline, and derivatives thereof as a monomer, and the valve action metal is preferably at least one kind selected from aluminum, tantalum and niobium.

According to the present invention, an electroconductive polymer suspension for providing an electroconductive polymer material with a high electroconductivity and a method for producing the same can be provided, and particularly a solid electrolytic capacitor with a low ESR and a method for producing the same can be provided.

### BRIEF DESCRIPTION OF THE DRAWING

FIG. 1 is a schematic cross-sectional view showing a configuration of a solid electrolytic capacitor according to one embodiment of the present invention.

### DETAILED DESCRIPTION OF THE PREFERRED EMBODIMENTS

The method for producing an electroconductive polymer suspension of the present invention is explained. In the method for producing an electroconductive polymer suspension of the present invention, the first step is to carry out chemical oxidative polymerization of a monomer providing an electroconductive polymer by using an oxidant in a solvent containing a first dopant to synthesize an electroconductive polymer; the second step is to purify the electroconductive polymer obtained by the first step; the third step is to add a second dopant, to mix an oxidant, to subsequently add a third dopant, and to further mix an oxidant in an aqueous solvent containing the purified electroconductive polymer; and the fourth step is to carry out an ion-exchange treatment to the mixture liquid obtained by the third step to obtain an electroconductive polymer suspension. Further, the fifth step is to add at least one kind selected from erythritol and pentaerythritol to the electroconductive polymer suspension obtained by the fourth step.

First, as the first step, chemical oxidative polymerization of a monomer providing an electroconductive polymer by using an oxidant in a solvent containing a first dopant including an polysulfonic acid or a salt thereof is carried out to synthesize an electroconductive polymer. By conducting the first step, an electroconductive polymer with high polymerization degree and high crystallinity can be obtained.

The monomer can appropriately be selected from monomers providing an electroconductive polymer. Specific examples of the monomer include pyrrole, thiophene, aniline and derivatives thereof. Specific examples of the derivative of pyrrole include 3-alkylpyrroles such as 3-hexylpyrrole, 3,4-dialkylpyrroles such as 3,4-dihexylpyrrole, 3-alkoxypyrroles such as 3-methoxypyrrole, and 3,4-dialkoxypyrroles such as 3,4-dimethoxypyrrole. Specific examples of the derivative of thiophene include 3,4-ethylenedioxythiophene and derivatives thereof, 3-alkylthiophenes such as 3-hexylthiophene, and 3-alkoxythiophenes such as 3-methoxythiophene. Specific examples of the derivative of aniline include 2-alkylanilines such as 2-methylaniline, and 2-alkoxyanilines such as 2-methoxyaniline. Among these, 3,4-ethylenedioxythiophene represented by following formula (1) or a derivative thereof is preferable from the viewpoint of electroconductivity. Examples of the derivative of 3,4-ethylenedioxythiophene include 3,4-(1-alkyl)ethylenedioxythiophenes such as 3,4-(1-hexyl)ethylenedioxythiophene. The monomer may be used alone, or in combination with two or more kinds.

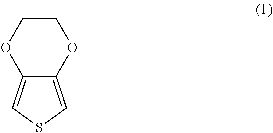

The concentration of the monomer in the solution is not particularly limited because the monomer can be removed in the second step even when it is excessive, however, is preferably 0.5 to 70.0% by mass for obtaining an electroconductive polymer with a high electroconductivity in good yield, and is more preferably 1.0 to 50.0% by mass.

As the first dopant, a polysulfonic acid or a salt thereof is used. Specific examples thereof include polystyrene sulfonic acids, polyvinyl sulfonic acids, polyester sulfonic acids, poly(2-acrylamide-2-methylpropane sulfonic acids) and copolymers having a structural unit thereof. Specific examples of the salt of polysulfonic acid include lithium salts, sodium salts, potassium salts, and ammonium salts.

Among these, polystyrene sulfonic acids having a structural unit represented by following formula (2) are preferable. The weight average molecular weight of the polysulfonic acid is preferably 500000 or less, and is more preferably 200000 or less for obtaining an electroconductive polymer with a high electroconductivity. The first dopant may be used alone, or in combination with two or more kinds.

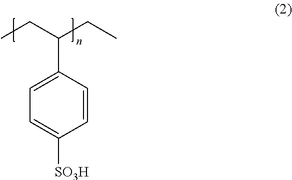

The amount used of the first dopant is not particularly limited because the first dopant can be removed in the second step even when it is excessively added, however, is preferably 0.1 to 100.0 parts by mass with respect to 1 part by mass of the monomer for obtaining an electroconductive polymer with a high electroconductivity, and is more preferably 0.1 to 20.0 parts by mass.

The solvent used for carrying out this reaction is preferably selected from solvents having a good compatibility with the monomer, and may be water, an organic solvent or a water-containing organic solvent. Specific examples of the organic solvent include alcohol solvents such as methanol, ethanol and propanol, aromatic hydrocarbon solvents such as benzene, toluene and xylene, aliphatic hydrocarbon solvents such as hexane, and aprotic polar solvents such as N,N-dimethylformamide, dimethylsulfoxide, acetonitrile and acetone. The organic solvent may be used alone, or in combination with two or more kinds. Among these, ethanol, or a mixed solvent of ethanol or dimethylsulfoxide with water is preferable.

The oxidant is not particularly limited. Examples of the usable oxidant include iron (III) salts of an inorganic acid such as iron (III) chloride hexahydrate, anhydrous iron (III) chloride, iron (III) nitrate nonahydrate, anhydrous ferric nitrate, iron (III) sulfate n-hydrate (n=3 to 12), ammonium iron (III) sulfate dodecahydrate, iron (III) perchlorate n-hydrate (n=1, 6) and iron (III) tetrafluoroborate; copper (II) salts of an inorganic acid such as copper(II) chloride, copper (II) sulfate and copper (II) tetrafluoroborate; nitrosonium tetrafluoroborate; persulfates such as ammonium persulfate, sodium persulfate and potassium persulfate; periodates such as potassium periodate; hydrogen peroxide, ozone, potassium hexacyanoferrate (III), tetraammonium cerium (IV) sulfate dihydrate, bromine and iodine; and iron (III) salts of an organic acid such as iron (III) p-toluenesulfonate. Among these, the salts of an inorganic acid or the persulfates are preferable from the viewpoint of electroconductivity, and ammonium persulfate is more preferable. The oxidant may be used alone, or in combination with two or more kinds.

The amount used of the oxidant is not particularly limited because the oxidant can be removed by the purification in the second step even when it is excessively added, however, is preferably 0.5 to 100.0 parts by mass with respect to 1 part by mass of the monomer for obtaining an electroconductive polymer with a high electroconductivity by the reaction under a milder oxidation atmosphere, and is more preferably 1.0 to 40.0 parts by mass.

The first step can be conducted in a presence of a surfactant. Since the monomer has a low solubility to water, the use of a surfactant in the case where water is used as a solvent can improve a dispersibility of the monomer. The surfactant may be an anionic surfactant, a cationic surfactant, an amphoteric surfactant or a nonionic surfactant, and is preferably dodecyl benzene sulfonic acid or polyethylene glycol. The surfactant may be used alone, or in combination with two or more kinds.

The amount used of the surfactant is not particularly limited because the surfactant can be removed by the purification in the second step even when it is excessively added, however, is preferably 0.01 to 10.0 parts by mass with respect to 1 part by mass of the monomer, and is more preferably 0.1 to 5.0 parts by mass.

The electroconductive polymer obtained by chemical oxidative polymerization of the monomer has a structural unit derived from the monomer. For example, in the case where 3,4-ethylenedioxythiophene represented by formula (1) is used as a monomer, the electroconductive polymer obtained has a structural unit represented by following formula (3).

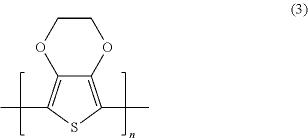

The chemical oxidative polymerization is preferably carried out with stirring. The reaction temperature of the chemical oxidative polymerization is not particularly limited, but the upper limit may be a reflux temperature of the solvent used. It is preferably 0 to 100° C., and is more preferably 10 to 50° C. If the reaction temperature is not proper, the electroconductivity of the electroconductive polymer obtained may be lowered. The reaction time of the chemical oxidative polymerization depends on the kind and the amount used of the oxidant, the reaction temperature and the stirring condition, but it is preferably approximately 5 to 100 hours. When an electroconductive polymer is formed, the color of the reaction liquid is changed to dark blue.

Next, as the second step, the electroconductive polymer is purified. Concretely, the electroconductive polymer is separated from a reaction liquid containing the electroconductive polymer obtained by chemical oxidative polymerization and is washed to remove the dopant, the monomer, the oxidant and the reacted oxidant. By conducting the second step, an electroconductive polymer with high purity can be obtained. Examples of the method for separating the electroconductive polymer from the reaction liquid include filtration method and centrifugal method.

The washing solvent used in the second step is preferably a solvent in which the electroconductive polymer is not dissolved and the monomer and/or the oxidant can be dissolved. Specific examples of the washing solvent include water and alcohol solvents such as methanol, ethanol and propanol. The washing solvent may be used alone, or in combination with two or more kinds. The extent of washing can be confirmed by measuring the pH of the washing solvent after washing or by carrying out colorimetric observation by using an examination reagent or the like.

Further, since it is possible to remove a metal component derived from the oxidant, a halogen and a sulfuric acid component more highly, it is preferable to wash the electroconductive polymer with hot water and/or to wash it with an organic solvent and/or to heat treat it. The organic solvent is preferably dimethylsulfoxide, N,N-dimethylformamide, dimethylacetamide or the like. The temperature of the heat treatment is not particularly limited as long as it is equal to or lower than the decomposition temperature of the electroconductive polymer, but it is preferably lower than 300° C. Also, it is efficient as a method for removing a component derived from the oxidant to carrying out a known ion-exchange treatment by using an ion exchange resin. The impurity contained in the electroconductive polymer can be analyzed by atomic absorption method analysis, ICP emission analysis, ion chromatography or the like.

Then, in the third step, the purified electroconductive polymers are dispersed in an aqueous solvent, and an aqueous solution containing a polyacid component as a second dopant is added, and an oxidant is mixed. After that, an organic acid with a low molecular weight or a salt thereof as a third dopant is added, and an oxidant is mixed to obtain an electroconductive polymer suspension.

Since the polyacid functions as a dispersing agent in the third step, an electroconductive polymer suspension with good dispersibility can be obtained. As a dispersing mechanism, at least a doping effect of a polyanion derived from the polyacid component is considered.

The aqueous solvent is preferably water and may be a mixed solvent of water and a water-soluble organic solvent. Specific examples of the water-soluble organic solvent include protic polar solvents such as methanol, ethanol, propanol, and acetic acid, and aprotic polar solvents such as N,N-dimethylformamide, dimethylsulfoxide, acetonitrile and acetone.

The concentration of the electroconductive polymer in the aqueous solvent is preferably 0.1 to 20.0% by mass for improving the dispersibility, and is more preferably 0.5 to 10.0% by mass.

A polyacid or a salt thereof can be used as the polyacid component that is a second dopant. Specific examples of the polyacid include polycarboxylic acids such as polyacrylic acids, polymethacrylic acids and polymaleic acids, polysulfonic acids such as polyvinyl sulfonic acids, poly(2-acrylamide-2-methylpropanesulfonic acid) and polystyrene sulfonic acids, and copolymers having a structural unit thereof. Specific examples of the salt of the polyacid include lithium salts, sodium salts, potassium salts and ammonium salts of the polyacids. Among these, polystyrene sulfonic acids having a structural unit represented by formula (2) are preferable. The polyacid component may be used alone, or in combination with two or more kinds.

The weight average molecular weight of the polyacid component is preferably 2000 to 500000 for obtaining an electroconductive polymer with a high electroconductivity, and is more preferably 10000 to 200000.

The amount used of the polyacid component is preferably 20 to 3000 parts by mass with respect to 100 parts by mass of the electroconductive polymer for obtaining an electroconductive polymer with a high electroconductivity, and is more preferably 20 to 1000 parts by mass.

Further, by adding the organic acid with a low molecular weight or the salt thereof as a third dopant and by mixing the oxidant, a dope rate of the electroconductive polymer can be improved. This is presumed to be because the molecular weight of the organic acid with a low molecular weight or the salt thereof is lower than that of the polyacid component and thereby the dope rate of the electroconductive polymer is raised and the electroconductivity can be improved.

Specific examples of the organic acid with a low molecular weight or the salt thereof include benzenesulfonic acid, naphthalenesulfonic acid, anthraquinonesulfonic acid, camphorsulfonic acid, alkyl sulfonic acids and derivatives thereof and iron (Ill) salts thereof. Also, the organic acid with a low molecular weight may be a monosulfonic acid, disulfonic acid and trisulfonic acid. Specific examples of the derivative of the alkyl sulfonic acid include 2-acrylamide-2-methylpropanesulfonic acid.

Specific examples of the derivative of benzenesulfonic acid include phenolsulfonic acid, styrenesulfonic acid, toluenesulfonic acid, and dodecyl benzene sulfonic acid. Specific examples of the derivative of naphthalenesulfonic acid include 1-naphthalenesulfonic acid, 2-naphthalenesulfonic acid, 1,3-naphthalenedisulfonic acid, 1,3,6-naphthalenetrisulfonic acid and 6-ethyl-1-naphthalenesulfonic acid. Specific examples of the derivative of anthraquinonesulfonic acid include anthraquinone-1-sulfonic acid, anthraquinone-2-sulfonic acid, anthraquinone-2,6-disulfonic acid and 2-methylanthraquinone-6-sulfonic acid. Among these, 1-naphthalenesulfonic acid, 2-naphthalenesulfonic acid, 1,3,6-naphthalenetrisulfonic acid, anthraquinonedisulfonic acid, p-toluenesulfonic acid, camphorsulfonic acid or the iron (III) salts thereof are preferable.

Further, from the point of improving the electroconductivity, naphthalenesulfonic acid is preferable, and 2-naphthalenesulfonic acid is particularly preferable. The organic acid with a low molecular weight or the salt thereof may be used alone, or in combination with two or more kinds.

As the oxidant in the third step, the same oxidant in the first step can be used. Among these, ammonium persulfate or hydrogen peroxide is preferable. The amount used of the oxidant is preferably 0.5 to 50.0 parts by mass with respect to 1 part by mass of the electroconductive polymer obtained by the second step for obtaining an electroconductive polymer with a high electroconductivity, and is more preferably 1.0 to 30.0 parts by mass.

The reaction temperature of the third step is not particularly limited, but is preferably in a range of 0° C. to 100° C., and is more preferably 10° C. to 50° C. The reaction time of the third step is not particularly limited, but is approximately 5 to 100 hours.

Further, as the fourth step, the above-mentioned ion-exchange treatment is carried out after the third step. By carrying out the ion-exchange treatment, a residual ion component such as sulfuric acid ion which is derived from the oxidant can be removed. Also, by carrying out the ion-exchange treatment, it is possible to improve the film forming property of the electroconductive polymer when the electroconductive polymer suspension is dried and the solvent is removed. Of course, it is possible to substitute a well-known treatment step which corresponds to this.

It is preferable to conduct a fifth step of mixing at least one kind selected from erythritol and pentaerythritol after the fourth step. By conducting the fifth step, it is possible to realize a further higher electroconductivity because it interacts with the polyacid component (undoped dopant anion (resistance component)) which exists in the vicinity of the electroconductive polymers in the electroconductive polymer suspension, and thereby the resistance between the electroconductive polymer particles is lowered and the density of the electroconductive polymer is increased.

Erythritol is preferable because it has a higher crystallinity than, for example, those of polyols such as sorbitol and maltose, and thereby has a low hygroscopicity and is easy to be handled. Also, erythritol is known as a food additive used as a sweetener, and is excellent in safety and stability. Further, erythritol is several-fold higher in the solubility to water than, for example, non-aqueous solvent such as ethylene glycol and glycerin, and provides an advantage that there is a lot of flexibility in designing the addition amount thereof.

Pentaerythritol is characterized by being slowly sublimed when heated, and by being dehydrated and polymerized by the heating at a temperature equal to or higher than the melting point thereof. Thereby, pentaerythritol has an advantage that the properties of the organic material are changed to improve the density and the strength thereof. Such reactivity originates from the chemical structure thereof, and hardly results from the chemical structure such as that of erythritol or sorbitol.

A larger advantageous effect is realized by mixing erythritol or pentaerythritol in an amount so that the concentration of erythritol or pentaerythritol comes to be equal to or higher than that the concentration of the electroconductive polymer in the electroconductive polymer suspension. The upper limit of the mixing amount is not particularly limited as long as it can be dissolved in the electroconductive polymer suspension.

A resin which functions as a binding action may be added to the electroconductive polymer suspension obtained. Specific examples of this resin include polyester resins, polyethylene resins, polyamide resins, polyimide resins, polyether resins and polystyrene resins. The amount added of this resin is preferably 0.01 to 20 parts by mass with respect to 100 parts by mass of the electroconductive polymer suspension from the viewpoint of keeping the electroconductivity.

The electroconductive polymer suspension of the present invention is usually dark blue.

An electroconductive polymer material can be obtained by removing the solvent from the electroconductive polymer suspension of the present invention. This electroconductive polymer material has a high electroconductivity. Since this electroconductive polymer material has a high crystallinity of the electroconductive polymer and disperses light, it has no transparency and exhibits a color near black.

The removal of the solvent can be carried out by drying the electroconductive polymer suspension. The temperature of the drying is not particularly limited as long as it is equal to or lower than the decomposition temperature of the electroconductive polymer, but it is preferably 300° C. or lower.

Further, the electroconductive polymer material obtained by removing the solvent from the electroconductive polymer suspension of the present invention also has a property of low moisture absorbency. It is thought that it is caused by esterifying the undoped sulfonic acid group that is the polyacid in the electroconductive polymer suspension, erythritol and pentaerythritol during drying, resulting that the hydrophilic group disappears.

Also, the electroconductive polymer material obtained by removing the solvent from the electroconductive polymer suspension of the present invention can be used as a solid electrolyte layer of a solid electrolytic capacitor. Since the electroconductive polymer contained in the electroconductive polymer suspension or the electroconductive polymer material obtained by removing the solvent from the electroconductive polymer suspension has a high electroconductivity, a condenser with a low ESR can be obtained. Further, since the electroconductive polymer has a high crystallinity, the oxygen barrier property is also high associated with it and the improvement of the reliability of the condenser is also sufficiently anticipated.

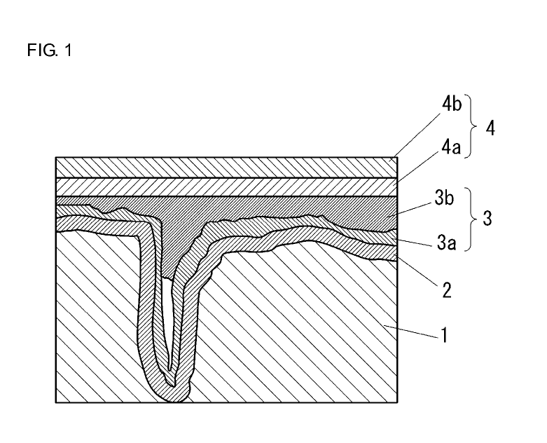

Next, a configuration of a solid electrolytic capacitor using the electroconductive polymer material obtained from the electroconductive polymer suspension and a production method is explained by using drawings. FIG. 1 is a schematic cross-sectional view showing a configuration of a solid electrolytic capacitor according to one embodiment of the present invention.

This solid electrolytic capacitor has a configuration in which dielectric layer 2, solid electrolyte layer 3 and cathode conductor 4 are formed in this order on anode conductor 1.

Anode conductor 1 is formed of: a plate, a foil or a wire of a valve action metal; a sintered body containing fine particles of a valve action metal; a porous metal subjected to a surface area enlargement treatment by etching; or the like. Specific examples of the valve action metal include tantalum, aluminum, titanium, niobium and zirconium, and alloys thereof. Among these, at least one valve action metal selected from aluminum, tantalum and niobium is preferable.

Dielectric layer 2 is a layer which can be formed by electrolytic oxidation of the surface of anode conductor 1, and is also formed in the pores of a sintered body or a porous body. The thickness of dielectric layer 2 can be appropriately adjusted by the voltage of the electrolytic oxidation.

Solid electrolyte layer 3 contains the electroconductive polymer material obtained by removing the solvent from the above-mentioned electroconductive polymer suspension. Examples of the method for forming solid electrolyte layer 3 include a method of application or impregnation of the above-mentioned electroconductive polymer suspension on dielectric layer 2, and of removing the solvent from the electroconductive polymer suspension The method of application or impregnation method is not particularly limited. However, in order to sufficiently fill the electroconductive polymer suspension in the interior of the pores of the porous material, it preferably leaves for a few minutes to a few tens of minutes after application or impregnation. It is preferable to repeat immersion or to operate it under a circumstance of a pressure reduced from atmospheric pressure or under a circumstance of an increased pressure.

The removal of the solvent from the electroconductive polymer suspension can be carried out by drying the electroconductive polymer. The temperature of the drying is not particularly limited as long as it is within a temperature range in which the solvent can be removed. However, from the viewpoint of preventing the degradation of the element by a heat, the upper limit of the temperature is preferably lower than 300° C. It is necessary to appropriately optimize the time of the drying according to the temperature of the drying, but it is not particularly limited as long as it is within a range in which the electroconductivity is kept.

Further, it may contain an electroconductive polymer containing pyrrole, thiophene, aniline or a derivative thereof, an oxide derivative such as manganese dioxide or ruthenium oxide, or an organic semiconductor such as TCNQ (7,7,8,8-tetracyanoquinodimethane complex salt).

For example, solid electrolyte layer 3 can be designed to have a two-layer structure of first solid electrolyte layer 3a and second solid electrolyte layer 3b. And, chemical oxidative polymerization or electropolymerization of a monomer providing an electroconductive polymer on dielectric layer 2 is carried out to form first solid electrolyte layer 3a containing the electroconductive polymer. Application or impregnation of the above-mentioned electroconductive polymer suspension on first solid electrolyte layer 3a is carried out and the solvent is removed from the electroconductive polymer suspension to form second solid electrolyte layer 3b.

As a monomer, at least one kind selected from pyrrole, thiophene, aniline and derivatives thereof can be used. As a dopant used for chemical oxidative polymerization or the electropolymerization of the monomer to obtain an electroconductive polymer, sulfonic acid compounds such as alkyl sulfonic acids, benzenesulfonic acid, naphthalenesulfonic acid, anthraquinonesulfonic acid, camphorsulfonic acid and the derivatives thereof are preferable. The molecular weight of the dopant used can be appropriately selected from low molecular weight compounds to high molecular weight compounds. The solvent may be water only or may also be a mixed solvent of water and a water-soluble organic solvent.

It is preferable that the electroconductive polymer which is contained in first solid electrolyte layer 3a and the electroconductive polymer which is contained in second solid electrolyte layer 3b contain at least the same polymer.

Cathode conductor 4 is not particularly limited as long as it is a conductor. For example, it can be designed to have a two-layer structure formed of graphite layer 4a and silver electroconductive resin layer 4b.

### EXAMPLES

As follows, the Examples of the present invention are concretely explained.

### Example 1

### (First Step)

1 g of 3,4-ethylenedioxythiophene as a monomer and 6 g of 20% aqueous solution of a polystyrene sulfonic acid (weight average molecular weight: 50000) as a first dopant were added to 100 mL of an ethanol aqueous solution, and it was stirred at room temperature for 30 minutes.

Then, 4.2 ml of 30% aqueous solution of ammonium persulfate as an oxidant was added thereto in 5 parts of the same amount every 10 minutes. After that, it was stirred at room temperature for 50 hours to carry out chemical oxidative polymerization and a polythiophene (3,4-ethylenedioxythiophene) was synthesized. During this, the color of the solution was changed from yellow via light green, green and light navy blue to black.

### (Second Step)

The solution obtained was filtered by using a pressure reduction filtration equipment to collect a powder. The powder was washed with pure water to remove the excessive oxidant and the excessive dopant. The washing with pure water was repeated until the acidity of the filtrate came to be a pH of 6 to 7. After that, the powder was further washed with ethanol to remove the monomer. The washing with ethanol was carried out until the filtrate came to be colorless and transparent. At this time, the powder exhibited dark blue. Further, after the washing, it was heated in a thermostatic oven at 125° C.

### (Third Step)

0.5 g of the powder after purification was dispersed in 50 ml of water and then 1.9 g of an aqueous solution containing a polystyrene sulfonic acid (weight average molecular weight: 50000) in 20% by mass which was a polyacid component as a second dopant was added thereto. 1.5 g of ammonium persulfate as an oxidant was added thereto and it was stirred at room temperature for 50 hours. Further, 1.0 g of 2-naphthalenesulfonic acid which was an organic acid with a low molecular weight as a third dopant was added, and 1.0 g of ammonium persulfate as an oxidant was added. After that, it was stirred under room temperature for 10 hours. The polythiophene suspension obtained was dark navy blue.

### (Fourth Step)

5 g of an amphoteric ion-exchange resin (product name: MB-1, ion-exchange type: —H and —OH, made by ORGANO CORPORATION) was mixed with 10 g of the polythiophene suspension obtained, and it was stirred under room temperature for 1 hour. This resulted in removing sulfate ion derived from the oxidant. Here, as compared to pH before the mixing with the ion exchange resin, it was confirmed to rise approximately 1 of pH.

The polythiophene suspension obtained was dropped onto a glass substrate in an amount of 100 μl and was dried in a thermostatic oven at 150° C. to form an electroconductive polymer film including an electroconductive polymer material. The surface resistance (QC) and the film thickness of the electroconductive polymer film were measured by four-terminal method to calculate the electroconductivity (S/cm) of the electroconductive polymer film. The result is shown in TABLE 1.

### Example 2

A polythiophene suspension was produced by the same method as that of Example 1 except that 3.0 g of 2-naphthalenesulfonic acid was added as a third dopant. Further, an electroconductive polymer film was formed by the same method as that of Example 1, and the electroconductivity of the electroconductive polymer film was calculated. The result is shown in TABLE 1.

### Example 3

A polythiophene suspension was produced by the same method as that of Example 1 except that 1.0 g of p-toluenesulfonic acid was added as a third dopant. Further, an electroconductive polymer film was formed by the same method as that of Example 1, and the electroconductivity of the electroconductive polymer film was calculated. The result is shown in TABLE 1.

### Example 4

A polythiophene suspension was produced by the same method as that of Example 1 except that 1.0 g of dodecylbenzenesulfonic acid was added as a third dopant. Further, an electroconductive polymer film was formed by the same method as that of Example 1, and the electroconductivity of the electroconductive polymer film was calculated. The result is shown in TABLE 1.

### Example 5

A polythiophene suspension was produced by further dissolving 1 g of erythritol in 10 g of the polythiophene suspension obtained in Example 1 at room temperature. And, an electroconductive polymer film was formed by the same method as that of Example 1, and the electroconductivity of the electroconductive polymer film was calculated, The result is shown in TABLE 1.

### Example 6

A polythiophene suspension was produced by further dissolving 0.5 g of pentaerythritol in 10 g of the polythiophene suspension obtained in Example 5 at room temperature. And, an electroconductive polymer film was formed by the same method as that of Example 1, and the electroconductivity of the electroconductive polymer film was calculated. The result is shown in TABLE 1.

### Comparative Example 1

A polythiophene suspension was produced by the same method as that of Example 1 except that the third dopant and the oxidant were not added in third step. And, an electroconductive polymer film was formed by the same method as that of Example 1, and the electroconductivity of the electroconductive polymer film was calculated. The result is shown in TABLE 1.

### Comparative Example 2

As an example of a conventional synthesis method of a suspension, 2.0 g of polystyrene sulfonic acid (weight average molecular weight: 50000), 0.5 g of 3,4-ethylenedioxythiophene and 0.05 g of iron (Ill) sulfate were dissolved in 20 ml of water and air was introduced for 24 hours to produce a polythiophene suspension. And, an electroconductive polymer film was formed by the same method as that of Example 1, and the electroconductivity of the electroconductive polymer film was calculated. The result is shown in TABLE 1.

### Example 7

Porous aluminum was used as an anode conductor including a valve action metal, and an oxide coating film was formed on the surface of the aluminum metal by anodic oxidation. Then, the anode conductor having the dielectric layer formed was immersed in and taken out from a monomer liquid, in which 10 g of pyrrole as a monomer was dissolved in 200 ml of pure water, and was immersed in and taken out from an oxidant liquid, in which 20 g of p-toluenesulfonic acid as a dopant and 10 g of ammonium persulfate as an oxidant were dissolved in 200 ml of pure water, in this order. These operations were repeated 10 times. A chemical oxidative polymerization was carried out to form a first solid electrolyte layer.

The polythiophene suspension produced in Example 1 was dropped onto the first solid electrolyte layer, and it was dried and solidified at 165° C. to form a second solid electrolyte layer. On the second solid electrolyte layer, a graphite layer and a silver-containing resin layer were formed in this order to obtain a solid electrolytic capacitor. The ESR of the solid electrolytic capacitor obtained was measured by using an LCR meter at a frequency of 100 kHz. The ESR value was normalized from the value of the total cathode area to the value of the unit area (1 cm²). The result is shown in TABLE 2.

### Example 8

A solid electrolytic capacitor was produced by the same method as that of Example 7 except that a second solid electrolyte layer was formed by using the polythiophene suspension produced in Example 6. The result of ESR measured by the same method as that of Example 7 is shown in TABLE 2.

### Comparative Example 3

A solid electrolytic capacitor was produced by the same method as that of Example 7 except that a second solid electrolyte layer was formed by using the polythiophene suspension produced in Comparative Example 1. The result of ESR measured by the same method as that of Example 7 is shown in TABLE 2.

### Comparative Example 4

A solid electrolytic capacitor was produced by the same method as that of Example 7 except that a second solid electrolyte layer was formed by using the polythiophene suspension produced in Comparative Example 2. The result of ESR measured by the same method as that of Example 7 is shown in TABLE 2.

TABLE 1

| | electroconductivity |
|---|---|
| Examples | (S/cm) |
| Example 1 | 200 |
| Example 2 | 150 |
| Example 3 | 180 |
| Example 4 | 170 |
| Example 5 | 280 |
| Example 6 | 300 |
| Comparative Example 1 | 110 |
| Comparative Example 2 | 60 |

TABLE 2

| Examples | ESR (mΩ · cm²) |
|---|---|
| Example 7 | 2.0 |
| Example 8 | 1.5 |
| Comparative Example 3 | 2.5 |
| Comparative Example 4 | 3.0 |

As shown in TABLE 1, the electroconductive polymer films obtained in Examples 1 to 4 had a higher electroconductivity than those obtained in Comparative Examples 1 and 2. The addition of the organic acid with a low molecular weight that is a third dopant in the third step is thought to result in the improvement of the dope rate in the electroconductive polymer. By these, the advantageous effect of the present invention could be confirmed.

Also, the electroconductive polymer films obtained in Examples 5 and 6 had a further higher electroconductivity than those obtained in Examples 1 to 4. It was thought that the addition of the fifth step enables the removal of an undoped polyacid component and results in decreasing the resistance between electroconductive polymer particles and increasing the density of the electroconductive polymer, and that the electroconductive polymer material with a high electroconductivity could be obtained.

Also, as shown in TABLE 2, the solid electrolytic capacitors obtained in Examples 7 and 8 had a lower ESR than those obtained in Comparative Examples 3 and 4. By these, the advantageous effect of the present invention could be confirmed.

The embodiment of this invention was explained by using the Examples in the above, but this invention is not limited to these Examples and includes an embodiment after a design variation within a scope of this invention. That is, this invention includes an embodiment after various changings or modifications which can be made by a person ordinarily skilled in the art.

What is claimed is:

1. A method for producing an electroconductive polymer suspension, comprising:
a first step of carrying out chemical oxidative polymerization of a monomer providing an electroconductive polymer by using an oxidant in a solvent comprising a first dopant comprising an organic acid or a salt thereof to synthesize an electroconductive polymer;
a second step of purifying the electroconductive polymer;
a third step of adding a second dopant, mixing an oxidant, subsequently adding a third dopant, and further mixing an oxidant in an aqueous solvent comprising the purified electroconductive polymer; and
a fourth step of carrying out an ion-exchange treatment to the mixture liquid obtained by the third step to obtain an electroconductive polymer suspension.

2. The method for producing an electroconductive polymer suspension according to claim 1, wherein the monomer is at least one kind selected from pyrrole, thiophene, aniline, and derivatives thereof.

3. The method for producing an electroconductive polymer suspension according to claim 2, wherein the monomer is 3,4-ethylenedioxythiophene.

4. The method for producing an electroconductive polymer suspension according to claim 1, wherein the first dopant and/or the second dopant are at least one kind selected from a polysulfonic acid or a salt thereof.

5. The method for producing an electroconductive polymer suspension according to claim 4, wherein the polysulfonic acid or the salt thereof is a polystyrene sulfonic acid.

6. The method for producing an electroconductive polymer suspension according to claim 1, wherein the third dopant is at least one kind selected from an organic acid with a low molecular weight or a salt thereof.

7. The method for producing an electroconductive polymer suspension according to claim 6, wherein the organic acid with a low molecular weight or the salt thereof is at least one kind selected from alkyl sulfonic acids, benzenesulfonic acid, naphthalenesulfonic acid, anthraquinonesulfonic acid, camphorsulfonic acid and derivatives thereof and iron (Ill) salts thereof.

8. The method for producing an electroconductive polymer suspension according to claim 1, comprising a fifth step of mixing at least one kind selected from erythritol and pentaerythritol after the fourth step.

9. An electroconductive polymer suspension obtained by the method according to claim 1.

10. An electroconductive polymer material obtained by removing the solvent from the electroconductive polymer suspension according to claim 9.

11. A solid electrolytic capacitor which comprises a solid electrolyte layer comprising the electroconductive polymer material according to claim 10.

12. The solid electrolytic capacitor according to claim 11, comprising an anode conductor comprising a valve action metal and a dielectric layer formed on a surface of the anode conductor, wherein the solid electrolyte layer is formed on the dielectric layer.

13. The solid electrolytic capacitor according to claim 11, wherein the solid electrolyte layer comprises a first solid electrolyte layer formed on the dielectric layer and a second solid electrolyte layer formed on the first solid electrolyte layer.

14. The solid electrolytic capacitor according to claim 12, wherein the valve action metal is at least one kind selected from aluminum, tantalum and niobium.

15. A method for producing a solid electrolytic capacitor, comprising:
forming a dielectric layer on a surface of an anode conductor comprising a valve action metal; and
carrying out application or impregnation of the electroconductive polymer suspension according to claim 9 on the dielectric layer and removing the solvent from the electroconductive polymer suspension to form a solid electrolyte layer comprising an electroconductive polymer material.

16. A method for producing a solid electrolytic capacitor, comprising:
forming a dielectric layer on a surface of an anode conductor comprising a valve action metal;
carrying out chemical oxidative polymerization or electropolymerization of a monomer providing an electroconductive polymer on the dielectric layer to form a first solid electrolyte layer comprising the electroconductive polymer; and
carrying out application or impregnation of the electroconductive polymer suspension according to claim 9 on the first solid electrolyte layer and removing the solvent from the electroconductive polymer suspension to form a second solid electrolyte layer.

17. The method for producing a solid electrolytic capacitor according to claim 16, wherein the electroconductive polymer comprised in the first solid electrolyte layer is a polymer obtained by chemical oxidative polymerization or electropolymerization of at least one kind selected from pyrrole, thiophene, 3,4-ethylenedioxythiophene, aniline, and derivatives thereof as the monomer.

18. The method for producing a solid electrolytic capacitor according to claim 15, wherein the valve action metal is at least one kind selected from aluminum, tantalum and niobium.
